(19) United States
(12) Patent Application Publication
(10) Pub. No.: US 2017/0039667 A1
(43) Pub. Date: Feb. 9, 2017

(54) SYSTEM FOR PROVIDING A TRANSPORTATION CALL SERVICE IN RESPONSE TO PASSENGER'S VEHICLE SELECTION AND METHOD USING THE SAME

(71) Applicant: NHN Entertainment Corporation, Seongnam-si (KR)

(72) Inventor: YuJung KIM, Seongnam-si (KR)

(21) Appl. No.: 15/227,554

(22) Filed: Aug. 3, 2016

(30) Foreign Application Priority Data
Aug. 3, 2015 (KR) 10-2015-0109365

(51) Int. Cl. G06Q 50/30; H04M 3/51; G06Q 20/10; G08G 1/00; G06F 17/30; H04M 3/42; G08G 1/13

(52) U.S. Cl. CPC G06Q 50/30; H04M 3/42357; H04M 3/51; G08G 1/13; G08G 1/202; G06F 17/30241; G06Q 20/10

(57) ABSTRACT

A system for providing a transportation call service in response to a passenger's vehicle selection, including: a transportation call server; a plurality of vehicle terminals; and a passenger terminal associated with a passenger, wherein each of the plurality of vehicle terminals are configured to transmit vehicle position information to the transportation call server, wherein the transportation call server is configured to: generate vehicle position display information using the vehicle position information; and transmit the vehicle position display information to the passenger terminal, wherein the passenger terminal is configured to: transmit departure information to the transportation call server; display the current position of the plurality of vehicles on a map using the vehicle position display information; select a vehicle; and transmit a vehicle selection signal to the transportation call server, and wherein the transportation call server is configured to assign the selected vehicle to the passenger.

### CROSS REFERENCE TO RELATED APPLICATION

This application claims priority from and the benefit of Korean Patent Application No. 10-2015-0109365, filed on Aug. 3, 2015, which is hereby incorporated by reference for all purposes as if fully set forth herein.

### BACKGROUND

Field

Exemplary embodiments relate to a transportation call server and a method for providing transportation call service. More specifically, exemplary embodiments relate to a transportation call server and a method for providing transportation call service using data communication with a plurality of passenger mobile devices and vehicle devices.

Discussion of the Background

In modern society, various transportation means are used to transport persons and materials. The most important thing in transportation services is efficient matching between supply and demand.

For example, a taxi call service is one of the well-known conventional transportation service that calls taxies on behalf of passengers with the demand for transportation service. In the taxi call services, when a passenger makes phone call to a service provider, an operator of the service provider finds available taxies near the passenger and assigns one of them to the passenger. Then, the assigned taxi will pick up the passenger.

However, in the conventional transportation call service such as a taxi call service, the passenger has little discretion over the operator's assignment of transportation service because the passenger cannot be involved during the assignment process. Also, the conventional transportation call service may have considerable time delay in service since it needs operators to receive phone call from passengers, find available transportations and contact the available transportation on behalf of the passengers. In addition, the service provider or drivers spend considerable expenses for hiring operators.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide transportation call service system including a passenger terminal, a vehicle terminal, and a transportation call server.

Additional aspects will be set forth in the detailed description which follows, and, in part, will be apparent from the disclosure, or may be learned by practice of the inventive concept.

Exemplary embodiments provide a system for providing a transportation call service in response to a passenger's vehicle selection, including: a transportation call server; a plurality of vehicle terminals including a wireless transceiver for communication through a data network, each of the plurality of vehicle terminals associated with a corresponding transportation vehicle; and a passenger terminal associated with a passenger and including a wireless transceiver for communication through a data network, wherein each of the plurality of vehicle terminals are configured to transmit vehicle position information to the transportation call server, the vehicle position information including current position of the corresponding transportation vehicle, wherein the transportation call server is configured to: generate vehicle position display information using the vehicle position information; and transmit the vehicle position display information to the passenger terminal, wherein the passenger terminal is configured to: transmit departure information to the transportation call server; display the current position of each of the plurality of vehicles on a map using the vehicle position display information; select a vehicle from the plurality of vehicles displayed on the map; and transmit a vehicle selection signal to the transportation call server, and wherein the transportation call server is configured to transmit the departure information to a selected vehicle terminal in response to the vehicle selection signal, the selected vehicle terminal associated with the selected vehicle.

The selected vehicle terminal is further configured to transmit a call acceptance signal to the transportation call server in response to receiving the departure information.

The transportation call server is further configured to: assign the selected vehicle to the passenger in response to the call acceptance signal; generate a vehicle assignment message; and transmit the vehicle assignment message to the passenger terminal.

Exemplary embodiments also provide a transportation call server for providing a transportation call service in response to a passenger's vehicle selection, including: a data communication unit configured to exchange data with a passenger terminal associated with a passenger and a vehicle terminal associated with a vehicle via a wireless transceiver; a control unit configured to: generate, using vehicle position information transmitted from the vehicle terminal, vehicle position display information; transmit the vehicle position display information to the passenger terminal for the passenger terminal to display a current position of the vehicle; receive a request for a call of the vehicle from the passenger terminal, wherein the request for a call includes departure information; and transmits the departure information to the vehicle terminal.

Exemplary embodiments also provide a method for providing a transportation call service in response to a passenger's vehicle selection through communication with a transportation call server, the method performed by a passenger terminal capable of wireless communication. The method includes receiving vehicle position information of a plurality of transportation vehicles from the transportation call server, wherein the vehicle position information is provided by each of the plurality of transportation vehicles, displaying position of each of the plurality of vehicles on a map according to the vehicle position information, transmitting destination information to the transportation call server, selecting a vehicle from the plurality of vehicles displayed on the map, and transmitting a vehicle selection signal to the transportation call server.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic diagram illustrating a transportation call service system according to an exemplary embodiment.

FIG. 2 is a block diagram illustrating an exemplary transportation call server of the transportation call service.

FIG. 3 is a flowchart illustrating an exemplary process for displaying position information of vehicles on a passenger terminal during the transportation call service.

FIG. 4 is an exemplary screenshot of displaying position information of vehicles on the passenger terminal of FIG. 3.

FIG. 5 is a flowchart illustrating a process for displaying vehicle information on the passenger terminal.

FIG. 6 is an exemplary screenshot of a passenger terminal displaying vehicle information on the passenger terminal.

FIG. 7 is a flowchart illustrating a process for displaying transportation fee information.

FIG. 8 is a flowchart illustrating processes after selecting a vehicle.

FIG. 9 is an exemplary screenshot of the passenger terminal displaying the selected vehicle on the passenger terminal.

FIG. 10 is a flow chart illustrating a payment process using the transportation call service system of FIG. 1.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and apparatus are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

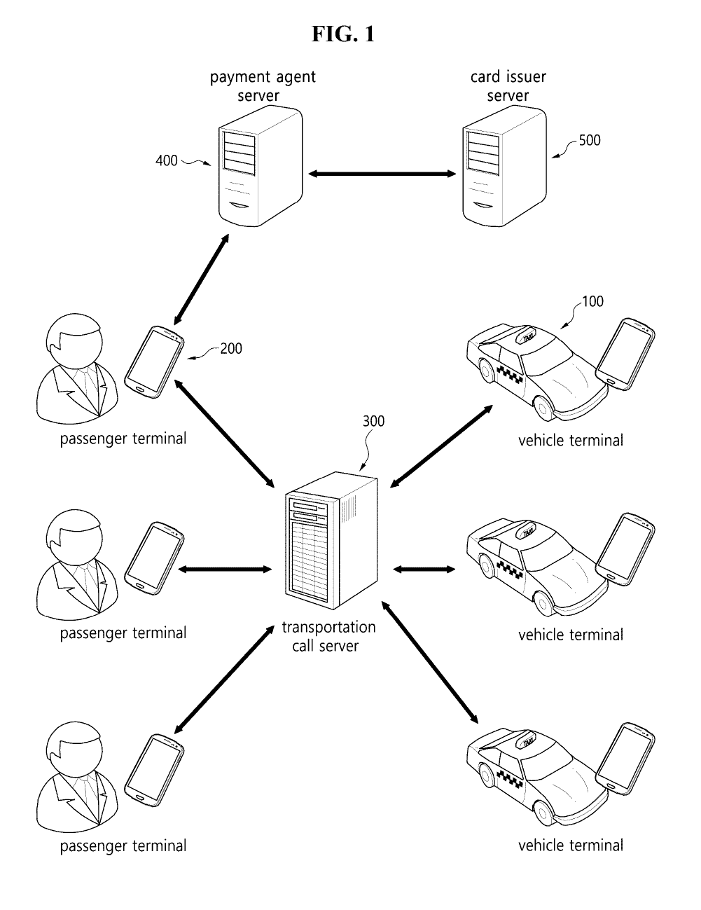

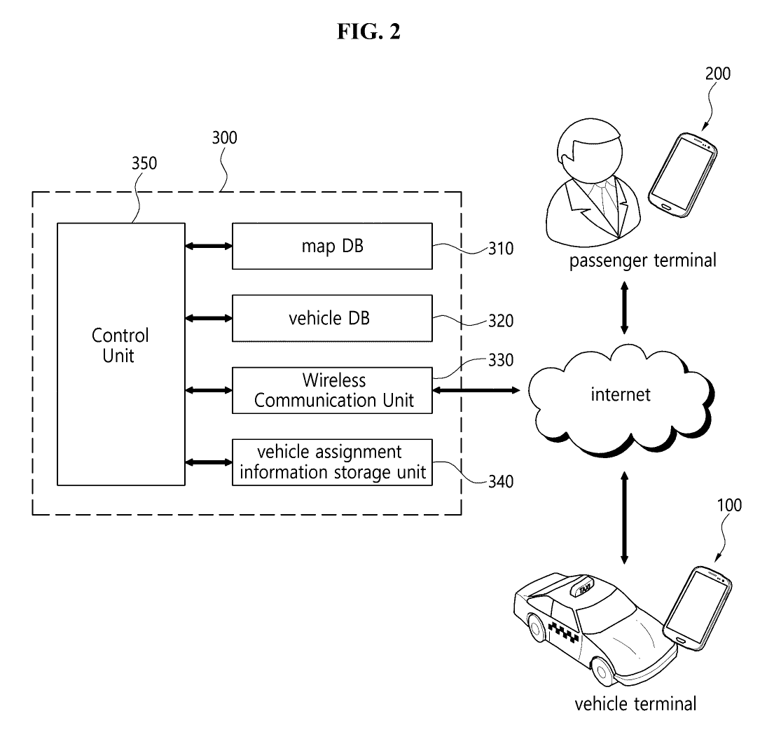

FIG. 1 is a schematic diagram illustrating a transportation call service system according to an exemplary embodiment, and FIG. 2 is a block diagram illustrating an exemplary transportation call server of the transportation call service.

Referring to FIG. 1 and FIG. 2, an exemplary transportation call service includes at least one of passenger terminals 200, at least one of vehicle terminals 100 and a transportation call server 300. The passenger terminals 200 and the vehicle terminals 100 may include smartphone, tablet, or notebook PC capable of wireless communication. The transportation call server 300 is connected to a data network to exchange signals with the passenger terminals 200, vehicle terminals 100 via respective wireless transceivers.

Each of the passenger terminals 200 belongs to a passenger who subscribed the transportation call service. Each of the vehicle terminals 100 is a computing device which belongs to a driver driving a transportation vehicle or is equipped to a vehicle. For example, the vehicle terminal 100 may be at least one of a smartphone, PDA, tablet and notebook PC a driver possesses or at least one of an infotainment system, tablet, or navigating system equipped to a transportation vehicle, but the exemplary embodiments are not limited thereto. The transportation call server 300 may provide the passenger terminal 200 and the vehicle terminal 100 with a transportation call service. Hereinafter, it will be described that the transportation call server 300 provides the passenger terminal 200 and the vehicle terminal 100 with a transportation call service.

The transportation call server 300 may include a map database (DB) 310, vehicle DB 320, wireless communication unit 330, vehicle assignment information storage 340 and control unit 350.

The map DB 310 stores geographic information including maps of service territories. The control unit 350 controls operation of the map DB 310 to load at least a part of the geographic information and update the map DB 310 if update is required.

The vehicle DB 320 stores vehicle information related to transportation vehicles subscribed to the transportation call service. The control unit 350 controls operation of the vehicle DB 320 to load at least a part of the vehicle information and update the vehicle DB 320 if update is required.

The wireless communication unit 330 may access the data network to exchange data with the passenger terminals 200 and vehicle terminals 100. The control unit controls operation of the wireless communication unit 330 to transmit various signals and data to the passenger terminals 200 and the vehicle terminals 100, and receive various signals and data from the passenger terminals 200 and the vehicle terminals 100.

The vehicle assignment information storage 340 stores vehicle assignment information. The vehicle assignment information includes real time status of vehicle assignment to passengers. The control unit 350 may load at least a part of the vehicle assignment information from the vehicle assignment information storage 340 and update the vehicle assignment information in real time when a new assignment between a passenger and a vehicle occurs and/or the status changes.

In exemplary embodiments, the map DB 310, the vehicle DB 320, the wireless communication unit 330, the vehicle assignment information storage 340 and the control unit 350, and/or one or more components thereof, may be implemented via one or more general purpose and/or special purpose components, such as volatile or non-volatile memory devices and one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the map DB 310, the vehicle DB 320, the wireless communication unit 330, the vehicle assignment information storage 340 and the control unit 350, and/or one or more components thereof may include or otherwise be associated with one or more memories (not shown) including code (e.g., instructions) configured to cause the map DB 310, the vehicle DB 320, the wireless communication unit 330, the vehicle assignment information storage 340 and the control unit 350, and/or one or more components thereof to perform one or more of the features, functions, processes, etc., described herein.

The memories and DBs may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

According to an exemplary embodiment, the passenger terminal 200 may be used for payment of transportation fee. More specifically, a passenger terminal 200 may transmits request for payment of transportation fee to an external payment agent server 400, then the external payment agent server 400 may process the payment of transportation fee according to the request for payment. In this case, if the request for payment includes information for easy payment, for example Paypal®, the external payment agent server may transmit the information for easy payment to associated card issuer server to process the payment of transportation fee. However, the exemplary embodiments are not limited thereto, and the passenger may pay the transportation fee in other method, for example, by cash, by real credit card, etc.

Hereinafter, a method of transportation call service using the above transportation call service system will be described in more detail.

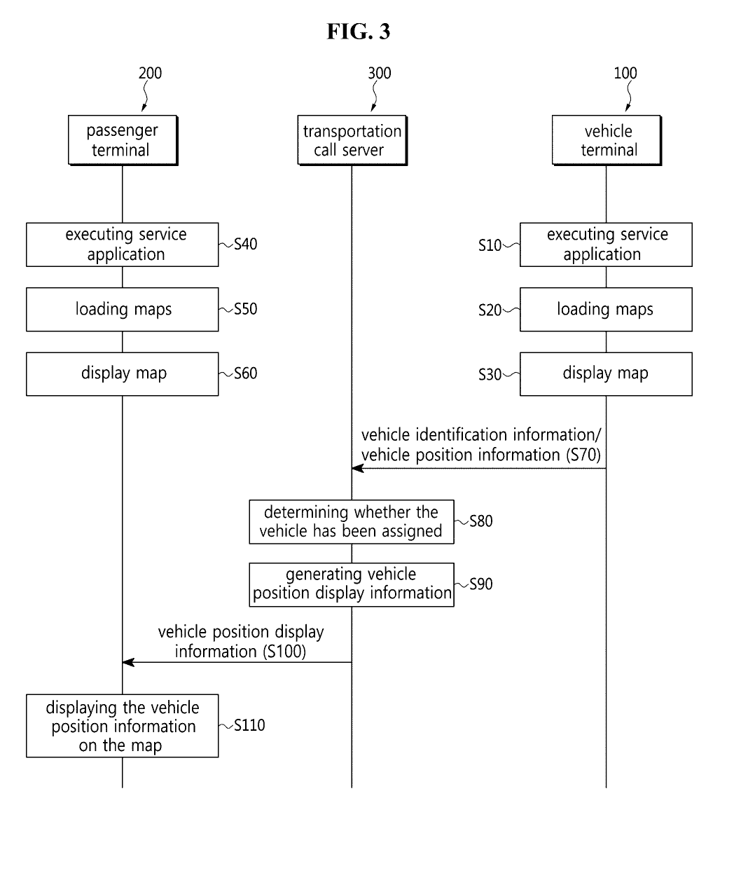

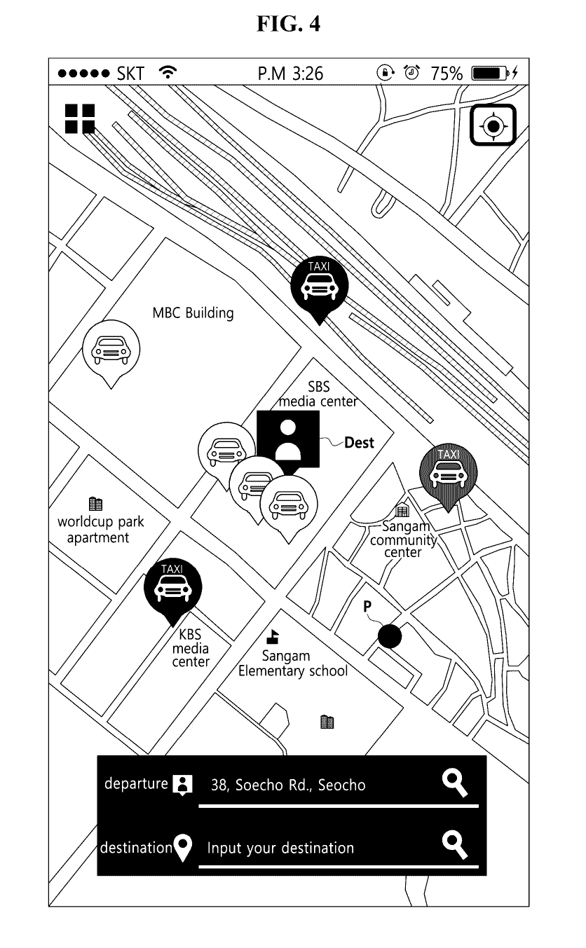

FIG. 3 is a flowchart illustrating an exemplary process for displaying position information of vehicles on a passenger terminal during the transportation call service. FIG. 4 is an exemplary screenshot of displaying position information of vehicles on the passenger terminal of FIG. 3.

Referring to FIG. 3 and FIG. 4, the vehicle terminals 100 execute a transportation call service application program for the transportation call service provided by the transportation call server 300 S10. Then, the vehicle terminals 100 load a map S20, and displaying the loaded map on a display device of the vehicle terminal 100 S30. In the step S20, the vehicle terminals 100 may download the map from the map DB 310 and store the map in the vehicle terminal 100 in advance, or may access the map DB 310 to receive a necessary part of the map in real time.

Meanwhile, the passenger terminal 200 execute a transportation call service application program for the transportation call service provided by the transportation call server 300 S40. Then, the passenger terminals 200 load a map S50, displaying the loaded map on a display device of the passenger terminal 200 S60. In the step S40, the vehicle terminals 100 may download the map from the map DB 310 and store the map in the passenger terminal 200 in advance, or may access the map DB 310 to receive a necessary part of the map in real time.

The application executed on the passenger terminal 200 and the application executed on the vehicle terminal 100 may be same application, or may partially have dedicated functions to each terminal in some aspects.

Each of the vehicle terminals 100 generates current position information of a vehicle on which the vehicle terminal 100 is equipped, using Global Positioning System (GPS) of the vehicle terminal 100 and then transmits the current position information to the transportation call server 300 S70. In the step S70, each of the vehicle terminals 100 may transmit vehicle identification information for identifying a vehicle with the vehicle position information to the transportation call server 300. The vehicle position information and the vehicle identification information transmitted by the vehicle terminal 100 may be received by the data communication unit 330 and transmitted to the control unit 350 via a wireless transceiver.

The control unit 350, using the vehicle identification information, inquires the vehicle assignment information stored in the vehicle assignment information storage 340 to determine whether the vehicle is assigned to one of the passengers S80. In this step, the control unit 350 may refer to the vehicle DB using the vehicle identification information to obtain the vehicle information.

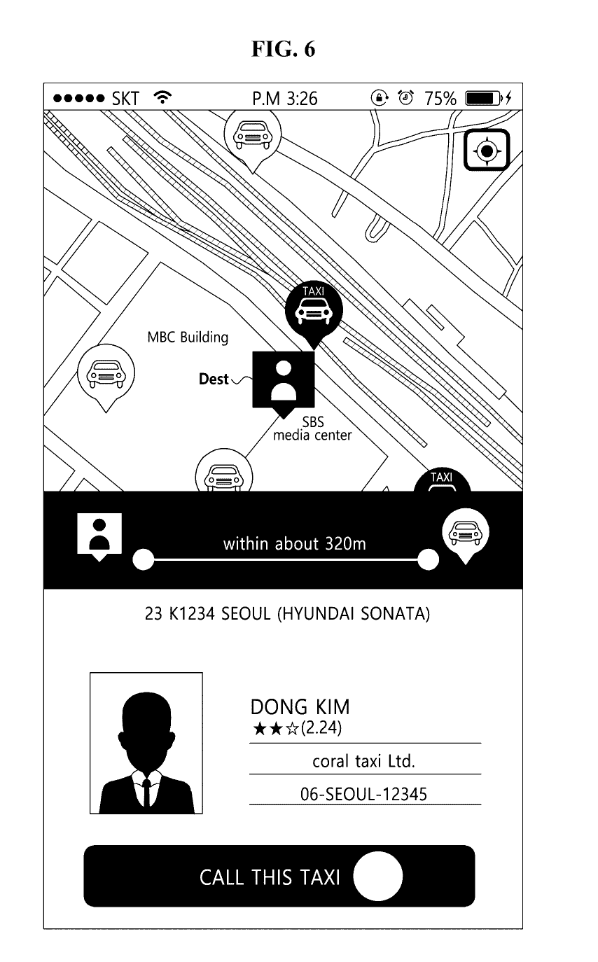

The control unit 350 generates, using the vehicle information, a vehicle position display information for displaying the vehicle positions S90. For example, the control unit 350 may generate the vehicle position display information using the vehicle position information received from the vehicle terminal 100 and the map information stored in the map DB 310. According to an exemplary embodiment, the vehicle position display information may be displayed on the passenger terminals, for example, using colors, description text, number, flickering, shapes, to indicate assignment status of the vehicles, types of the vehicle, and/or district that the vehicle belongs to. FIG. 6 illustrates an exemplary embodiment distinguishably displaying the assignment status of the vehicles using different colors.

According to an exemplary embodiment, the types of vehicle may include personal transportation vehicles for transporting persons to a single destination, shared transportation vehicles for transporting persons to a multiple destinations, and cargo vehicles for transporting goods. Also, all of the above-mentioned vehicles may also be autopilot vehicles transporting persons and/or goods, for example, drone. The vehicles include overland transport vehicle, e.g., cars, trucks, buses, bikes and the like, water transport vehicles, e.g., ship, boat and the like, and flight vehicles.

Meanwhile, the district the vehicle belongs to may be an administrative area where the vehicle is admitted to operate.

The control unit 350 transmits the vehicle position display information to the passenger terminals 200 through the wireless communication unit 330 S100. Meanwhile, the control unit 350 may further transmit the vehicle position display information to other vehicle terminals 100.

The passenger terminals 200 displays the current position of each of the vehicles on the loaded map using the received vehicle position display information S110. The passenger terminals 200 may be configured to display vehicles that are located within a predetermined distance from the passenger terminal.

Hereinafter, a process of assigning vehicles to a passenger who selects, calls, or requests the vehicle (hereinafter, “calling passenger”) will be described in more detail.

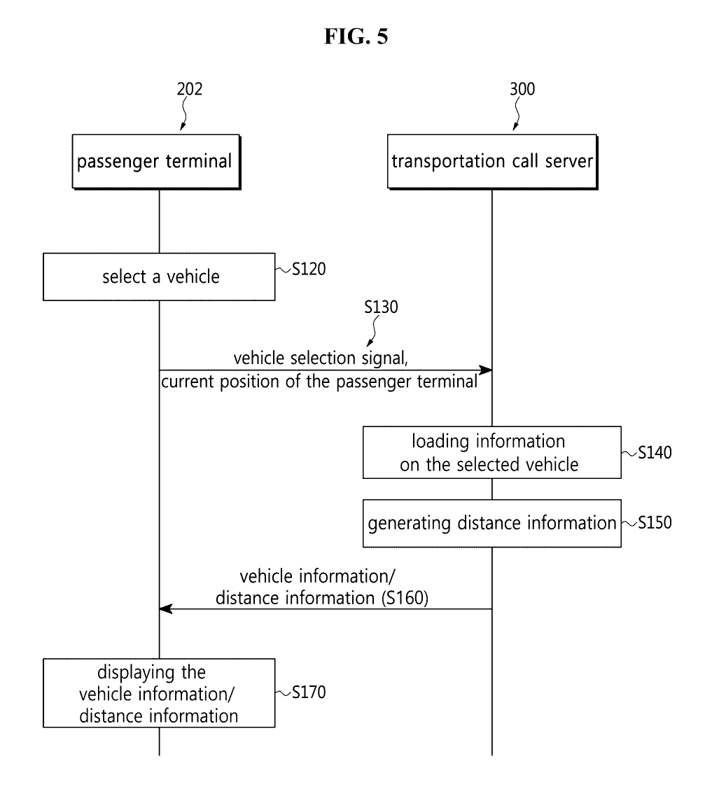

FIG. 5 is a flowchart illustrating a process for displaying a vehicle information on the passenger terminal 200 of the calling passenger (hereinafter, “calling passenger terminal 202”), and FIG. 6 is an exemplary screenshot of a passenger terminal displaying a vehicle information on the passenger terminal.

Referring to FIG. 5 and FIG. 6, when a passenger selects one vehicle from the vehicles displayed on the map through a user input interface, e.g. an touch display interface of the calling passenger terminal 202, and the calling passenger terminal 202 may generate a vehicle selection signal indicating that the vehicle is selected S120 and transmit the vehicle selection signal to the transportation call server 300 S130. The vehicle selection signal transmitted from the calling passenger terminal 202 may be received by the data communication unit 330 and transmitted to the control unit 350 via a transceiver.

According to an exemplary embodiment, the calling passenger terminal 202 may transmit a passenger terminal position information with the vehicle selection signal to the transportation call server 300 S130. The passenger terminal position information may be obtained by a GPS installed on the passenger terminal 200. For example, the calling passenger terminal 202 may obtain its position information using GPS in real time and transmit the obtained passenger terminal position information to the transportation call server 300 if necessary.

The control unit 350, in response to receiving the vehicle selection signal, may load vehicle information related to the selected vehicle from the vehicle DB S140. The vehicle information may include at least one of basic data of the vehicle, vehicle identification information, driver information of a driver driving the vehicle, and service grade information of the vehicle. The basic data of the vehicle may include type (e.g., taxi, ban, limousine), model (e.g., Ford Taurus, Chevrolet Impala), or other information (transportation capacity, speed, etc.) of the vehicle. The vehicle identification information is information by which the vehicle is identified, for example, plate number and/or transportation company of the vehicle. The driver information may include a name, phone number and address of the driver. The service grade information may be scores or reviews of the other passengers who used the vehicle.

The control unit 350 may generate distance information representing a distance between the calling passenger terminal 202 and the selected vehicle using the passenger terminal position information and the vehicle position information of the selected vehicle in real time or periodically S150. Also, the control unit 350 may further generate time information using the distance information. In this case, the control unit may use real time traffic information received from external traffic information provider, e.g., traffic monitoring system of police, in addition to the distance information to generate the time information.

The control unit 350 may transmit the vehicle information and distance information to the calling passenger terminal 202 through the data communication unit 330 S160. Also, the control unit 350 may transmit the time information to the calling passenger terminal 202.

The calling passenger terminal 202 may display the vehicle information and the distance information S170. The calling passenger terminal 202 may display the vehicle information and the distance information overlapped on the displayed map where a plurality of vehicles are displayed. In addition, the calling passenger terminal 202 may display the time information if received.

While the control unit transmits the vehicle information in response to the vehicle selection signal transmitted from a passenger terminal in the above described embodiment, the vehicle information may be provided by the transportation call server 300 without receiving the interested selection signal. For example, the transportation call server 300 may transmits the vehicle information on each of vehicles with the vehicle position display information at the same time, and then when a passenger selects one of the vehicles displayed on his or her terminal, the calling passenger terminal 202 may display the vehicle information related to the selected vehicle.

Also, while the control unit 350 generates and transmits the distance information and the time information, the calling passenger terminal 202 may generate the distance information and time information using the passenger position information and the vehicle position information provided by the transportation call server 300.

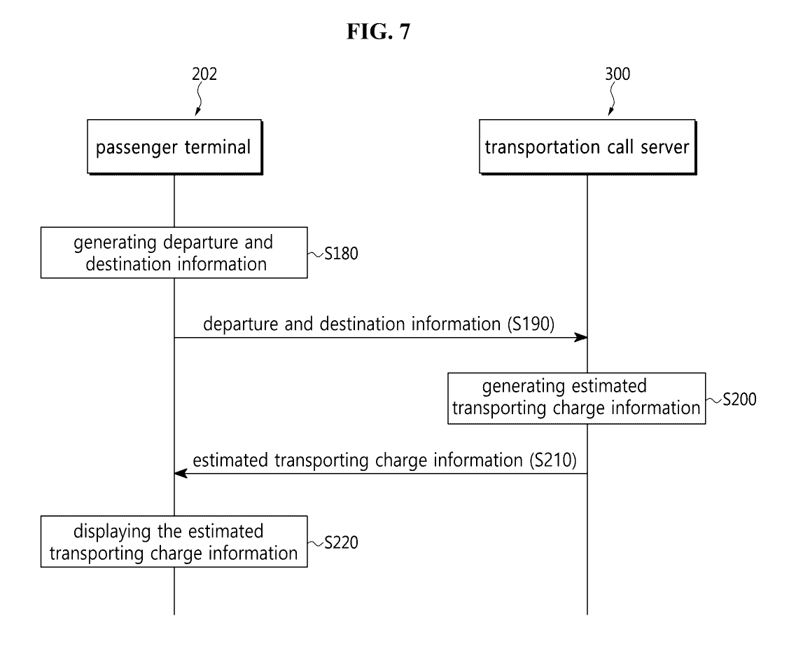

FIG. 7 is a flowchart illustrating a process for displaying transportation fee information.

Referring to FIG. 7, the calling passenger terminal 202 may generate at least one of departure information and destination information S180. The step S180 may be performed at any point after S110.

According to an exemplary embodiment, the departure information may include at least one of departure points where the passenger ride the vehicle. The departure point may be obtained by a GPS installed on the passenger terminal. The departure point may also be generated by a passenger input, for example, by passenger touching a point on the map displayed on the passenger terminal as illustrated in FIG. 4, or by passenger typing an address of the destination. The destination information include at least one of destination where the passenger gets off. Generating the destination information is the same as generating the departure information.

Meanwhile, when at least one of the departure information and destination information are generated, the calling passenger terminal 202 may display a plurality of vehicles on the map and the at least one of the departure information and destination information simultaneously. In the case that destination information is the current position of the passenger terminal, the passenger terminal displays only the current position of the passenger terminal based on passenger terminal position information. In case that the destination information is different from the current position of the calling passenger terminal 202, as shown in FIG. 4, the destination Dest may be displayed on the map separately from the current position P

The calling passenger terminal 202 transmits the at least one of the departure information and destination information S190. The at least one of the departure information and destination information transmitted from the calling passenger terminal 202 may be received by the data communication unit 330 and transmitted to the control unit 350.

The control unit 350 may calculate an estimated transportation fee based on a moving distance using the departure information and destination information S200.

The control unit 350 transmits the estimated transportation fee to the calling passenger terminal 202 S210.

The calling passenger terminal 202 displays the estimated transportation fee S220. The calling passenger terminal 202 may display the estimated transportation fee on the displayed map where a plurality of vehicles are displayed.

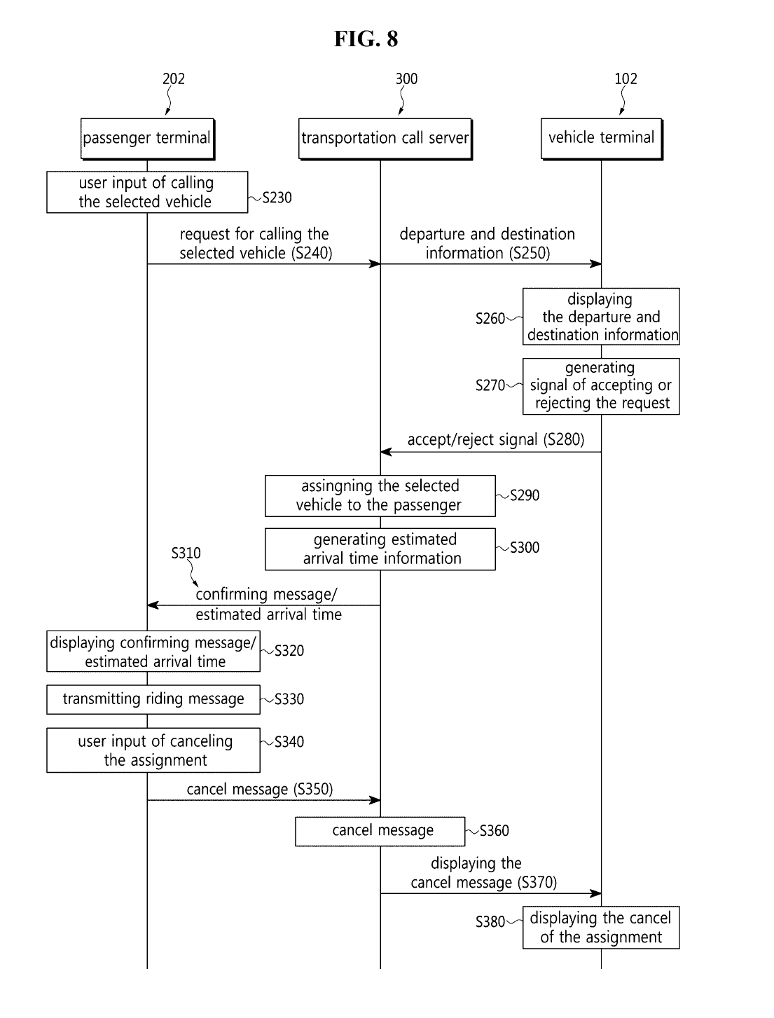

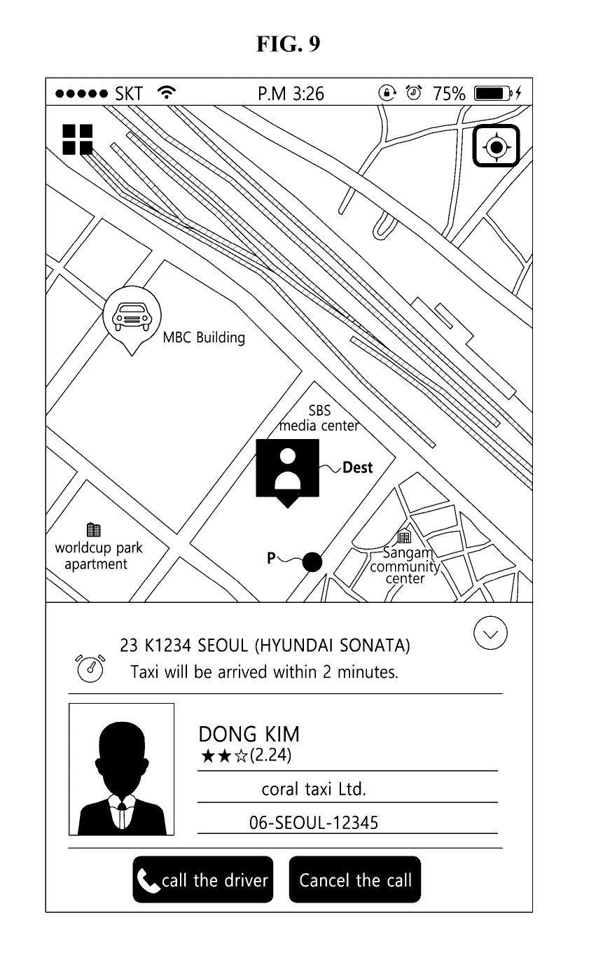

FIG. 8 is a flowchart illustrating processes after selecting a vehicle, and FIG. 9 is an exemplary screenshot of the passenger terminal displaying the selected vehicle on the calling passenger terminal 202.

Referring to FIG. 6, FIG. 8, and FIG. 9, the passenger may call the selected vehicle using a user interface S230. For example, the passenger terminal may provide a user touch interface (“CALL THIS TAXI” button interface in FIG. 6) within display of the vehicle information of the selected vehicle and a passenger can call the selected vehicle by touching the user touch interface.

On the other hand, the passenger terminal 200 may provide a user interface to stop displaying the vehicle when the calling passenger determines not to call the displayed vehicle or wants to see other vehicles. In an exemplary embodiment illustrating in FIG. 6, the passenger can eliminate the display of the vehicle by touching a cancel button.

The calling passenger terminal 202, in response to the user input, transmits a vehicle call request signal to the transportation call server 300. S240. The vehicle call request signal transmitted from the calling passenger terminal 202 may be received by the data communication unit 330 and transmitted to the control unit 350.

The control unit 350, in response to the vehicle call request, transmits the at least one of the departure information and destination information to the selected vehicle terminal (hereinafter “assigned vehicle terminal”) S250.

The assigned vehicle terminal 102 receives and displays the at least one of the departure information and destination information. In this case, the assigned vehicle terminal 102 may display the at least one of the departure information and destination information on the displayed map, or may provide them in a form of voice.

The assigned vehicle terminal 102, in response to receiving the departure information and destination information, may determine to accept or reject the request S270.

The assigned vehicle terminal 102 transmits an accept signal to the transportation call server 300 when the request is acceptable S280. The accept signal transmitted from the assigned vehicle terminal 102 may be received by the data communication unit 330 and transmitted to the control unit 350. On the other hand, the assigned vehicle terminal 102 may transmit a reject signal to the transportation call server 300 when the request is not acceptable. S280

The control unit 350, in response to receiving the accept signal, confirms to assign the called vehicle to the passenger S290. The control unit 350 generates vehicle assignment information that the called vehicle is assigned to the passenger, and stores the vehicle assignment information in the vehicle assignment information storage. Also, the control unit 350 may transmit a vehicle assignment message that the appointed vehicle is assigned to the passenger to the calling passenger terminal 202. On the other hand, the control unit may transmit a reject message to the calling passenger terminal 202 if the assigned vehicle terminal 102 transmits a reject signal that the request is rejected.

The control unit 350 may generate estimated arrival time information using the departure information and vehicle position information of the matched vehicle S300. The estimated arrival time is estimated time the matched vehicle take to arrive the departure point.

The control unit 350 transfers a vehicle assignment message with the estimated arrival time information to the calling passenger terminal 202 through the data communication unit 330 S310. On the other hand, if the request is rejected, the control unit 350 transmits a rejection message to the calling passenger terminal 202.

The calling passenger terminal 202, in response to receiving vehicle assignment message, displays the vehicle assignment message and the estimated arrival time as shown in FIG. 9.

The calling passenger terminal 202 may transmit a vehicle riding schedule message S330 to a predetermined terminal, for example, a mobile device of an acquaintance of the calling passenger. The vehicle riding schedule message may be transmitted as soon as receiving the vehicle assignment message, within a predetermined time after receiving the vehicle assignment message or after the calling passenger rides the matched vehicle. The riding message may be generated using the vehicle assignment message. For example, the passenger terminal extract the matched vehicle identification information, departure position, and estimated arrival time from the vehicle assignment message and generates a message that the calling passenger will ride the matched vehicle at the departure position at about the estimated arrival time. In addition, the vehicle riding schedule message may be transmitted automatically and/or in response to a user input. The vehicle riding schedule message may be transmitted using a social network service (SNS) and/or email. The vehicle riding schedule message may also include at least on of text, voice message, image and video for informing somebody of riding the appointed vehicle.

The calling passenger terminal 202 may provide a user interface for canceling the vehicle assignment S340. More specifically, the calling passenger may cancel the vehicle assignment using a user interface for cancel, for example, by touching a Cancel button as shown in FIG. 9.

The calling passenger terminal 202, in response to user input for cancel, generates and transmits a request for cancel to the transportation call server 300 S350.

The control unit 350 may, in response to receiving the request for cancel, confirm cancelation of the vehicle assignment S360. The control unit may change the vehicle assignment information stored in the vehicle assignment information storage according to the cancelation of the vehicle assignment.

The control unit transmits a cancelation message that the vehicle assignment is canceled to the assigned vehicle terminal 102 S370.

The assigned vehicle terminal 102, in response receiving the cancel message, may display the cancelation message S380.

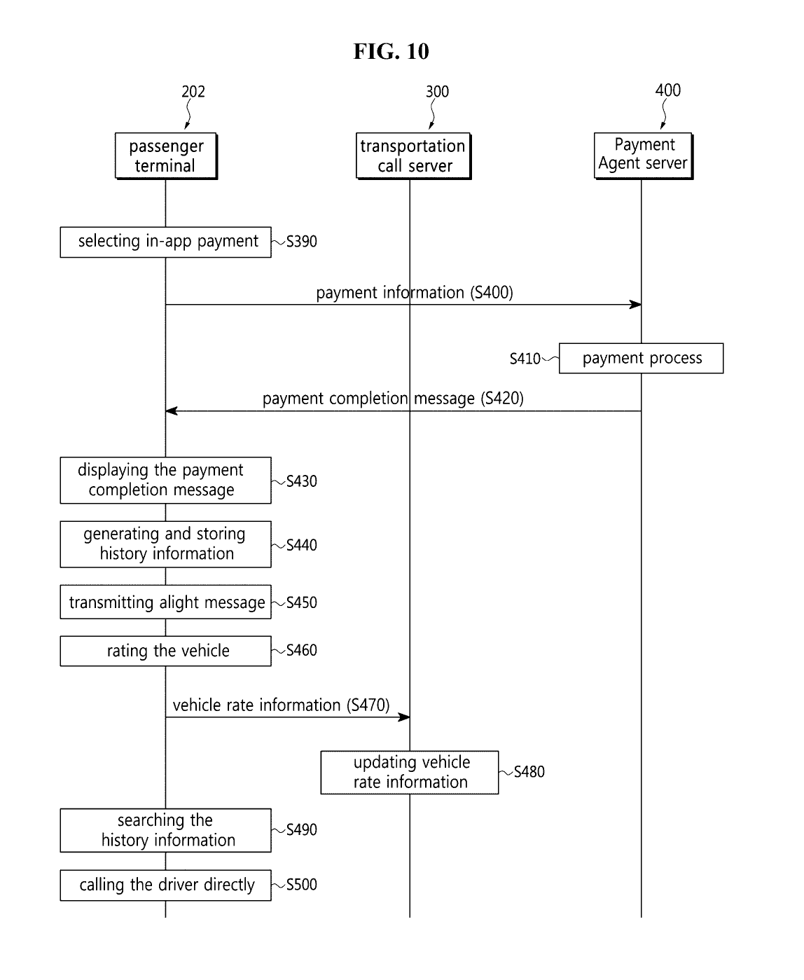

FIG. 10 is a flow chart illustrating a payment process using the transportation call service system of FIG. 1.

Referring to FIG. 10, when the assigned vehicle arrives at the destination, the passenger may pay the transportation fee using the calling passenger terminal 202 S390. For example, the calling passenger terminal 202 may be connected to the vehicle terminal 102 (not shown) through a Near Field Communication (NFC) or other wireless communication network for payment.

The calling passenger terminal 202 may access a payment agent server 400 to request for payment of the transportation fee S400.

The payment agent server 400, in response to request for payment, processes the payment of the transportation fee S410. In this case, the payment process may be an easy payment process such as Paypal®.

The payment agent server 400, in response to completion of payment process, transmits a payment completion message S420 to the calling passenger terminal 202.

The calling passenger terminal 202, in response to receiving the payment completion message, displays the payment is completed S430.

According to an exemplary embodiment, the passenger terminal may generate and store a service history after a call service is completed S440. The service history may be transmitted to the transportation call server 300 and stored in the transportation call server 300.

The calling passenger terminal 202 may generate an alight message that the passenger got off the assigned vehicle safely, and transmit the alight message to a predetermined device S450. Detailed characteristics of the alight message is similar to the riding schedule message. The vehicle riding schedule message may be transmitted using a SNS and/or email. In the meantime, the vehicle riding schedule message may include at least on of text, voice message, image and video informing somebody of riding the assigned vehicle.

The alight message may be generated and transmitted automatically in response to a service completion signal. The service completion signal may be the payment completion message, a signal generated by the payment completion message, a signal generated by a user input, a signal received from the transportation call server 300 or the assigned vehicle terminal 102 (not shown). Also, the service completion signal may be a signal generated in response to the passenger closing the service application. In addition, the alight message may be transmitted automatically and/or in response to a user input. The alight message may be generated using the vehicle assignment message. For example, the passenger terminal extract the assigned vehicle identification information, destination position from the vehicle assignment message and generates a message that the calling passenger get off the assigned vehicle at the destination position.

The calling passenger terminal 202 may generate service rating information S460. The step of S460 may be performed after receiving the payment completion message.

The calling passenger terminal 202 may transmit the generated service rating information to the transportation call server 300 S470.

The control unit 350, in response to receiving the service rating information, updates the rating of the vehicle stored in the vehicle information DB S480.

Meanwhile, the calling passenger terminal 202 may search and display the service history stored in the step S440 S490.

The calling passenger terminal 202 may try to call or send a message to the assigned vehicle terminal 102 using the displayed service history, for example, to retrieve any belongings that the passenger left behind in the vehicle S500. In other word, the passenger can get in touch with the driver using driver's phone number or other contact information included in the service history.

According to exemplary embodiments of the present invention, a passenger can call a transportation easily and the passenger may have higher discretion in deciding which transportation to call. Also, drivers or operators of transportations can find passengers more efficiently.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A system for providing a transportation call service in response to a passenger's vehicle selection, comprising:
a transportation call server;
a plurality of vehicle terminals comprising a wireless transceiver for communication through a data network, each of the plurality of vehicle terminals associated with a corresponding transportation vehicle; and
a passenger terminal associated with a passenger and comprising a wireless transceiver for communication through a data network,
wherein each of the plurality of vehicle terminals are configured to transmit vehicle position information to the transportation call server, the vehicle position information comprising current position of the corresponding transportation vehicle,
wherein the transportation call server is configured to: generate vehicle position display information using the vehicle position information; and transmit the vehicle position display information to the passenger terminal,
wherein the passenger terminal is configured to: transmit departure information to the transportation call server; display the current position of each of the plurality of vehicles on a map using the vehicle position display information; select a vehicle from the plurality of vehicles displayed on the map; and transmit a vehicle selection signal to the transportation call server, and
wherein the transportation call server is configured to transmit the departure information to a selected vehicle terminal in response to the vehicle selection signal, the selected vehicle terminal associated with the selected vehicle.

2. The system of claim 1, wherein the selected vehicle terminal is further configured to transmit a call acceptance signal to the transportation call server in response to receiving the departure information,
the transportation call server is further configured to: assign the selected vehicle to the passenger in response to the call acceptance signal; generate a vehicle assignment message; and transmit the vehicle assignment message to the passenger terminal.

3. The system of claim 2, wherein the transportation call server is further configured to: generate estimated arrival time using the vehicle position information and the departure information; and transmit the estimated arrival time to the passenger terminal, and
the passenger terminal is configured to display the estimated arrival time.

4. The system of claim 2, wherein the passenger terminal is further configured to: display vehicle assignment message; and transmit a riding schedule message to a predetermined terminal.

5. The system of the claim 2, wherein the passenger terminal is, in response to a user input for cancellation, further configured to: generate a cancel signal for cancelation of a vehicle assignment; and transmit the cancel signal to the transportation call server, and
wherein the transportation call server is, in response to receiving the cancel signal, further configured to: cancel the vehicle assignment; and transmit an assignment cancel message to the selected vehicle terminal.

6. The system of claim 1, wherein the passenger terminal is further configured to generate and store service history information.

7. The system of claim 6, wherein the passenger terminal is further configured to load the history information to contact a vehicle terminal stored in the history information.

8. The system of claim 1, wherein the passenger terminal is configured to transmit an alight message to a predetermined terminal in response to a service completion signal.

9. The system of claim 1, wherein the passenger terminal is further configured to: generate service quality rating information; and transmit the service quality rating information to the transportation call server, and
wherein the transportation call server is configured to store the service quality rating information.

10. The system of claim 1, wherein the transportation call server is further configured to provide the passenger terminal with vehicle information of the selected vehicle.

11. The system of claim 10, wherein the transportation call server is further configured to: generate distance information using the vehicle position information of the selected vehicle; and transmit the distance information to the passenger terminal, and
wherein the passenger terminal is configured to display the distance information.

12. The system of claim 11, the passenger terminal further configured to display time information according to the distance information.

13. The system of claim 10, wherein the vehicle information comprises: at least one of vehicle information comprising vehicle identification number, driver information comprising name and phone number of a driver of the vehicle, and service quality information.

14. The system of claim 1, wherein each vehicle terminal is configured to transmit vehicle identification information for identifying the vehicle to the transportation call server,
the transportation call server is configured to inquire a vehicle database (DB) to identify at least one of a type of the vehicle and a district the vehicle belongs to, using the vehicle identification information, and
the vehicle position information is used by the passenger terminal to distinguishably display the vehicle according to identification of at least one of the type of the vehicle and district the vehicle belongs to.

15. The system of claim 14, wherein the type of the vehicle comprises at least one of personal transportation vehicle, cargo transportation vehicle, and mass transportation.

16. The system of claim 1, the transportation call server is further configured to: determine whether the selected vehicle is assigned to another passenger; generate availability information according to determination of whether the vehicle is assigned to another passenger; and transmit the availabilty information in association with the vehicle position display information to the passenger terminal.

17. The system of claim 1, wherein the departure information comprises a current position of the passenger terminal.

18. The system of claim 1, wherein the departure information comprises a user input of a destination through a departure input user interface.

19. The system of claim 1, wherein the vehicle terminal of the selected vehicle is configured to display the departure position information using at least one of image and voice.

20. The system of claim 1, wherein the passenger terminal is configured to load the map stored in a memory of the passenger terminal.

21. The system of claim 1, wherein the passenger terminal is configured to: generate a destination information according to a user input; and transmit the destination information to the transportation call server.

22. The system of claim 21, wherein the destination information is input by a user by touching a point of the map displayed on the passenger terminal.

23. The system of claim 22, wherein the transportation call server is configured to transmit the destination information to the selected vehicle terminal.

24. The system of claim 23, wherein the transportation call server is configured to: generate an estimated charge information using the departure information and destination information and transmit the estimated charge information to the passenger terminal, and
wherein the passenger terminal is configured to display the estimated charge information.

25. The system of claim 1, wherein the passenger terminal is further configured to display at least one of the departure position information and a current position of the passenger terminal.

26. A transportation call server for providing a transportation call service in response to a passenger's vehicle selection, comprising:
a data communication unit configured to exchange data with a passenger terminal associated with a passenger and a vehicle terminal associated with a vehicle via a wireless transceiver;
a control unit configured to:
generate, using vehicle position information transmitted from the vehicle terminal, vehicle position display information;
transmit the vehicle position display information to the passenger terminal for the passenger terminal to display a current position of the vehicle;
receive a request for a call of the vehicle from the passenger terminal, wherein the request for a call comprises departure information; and
transmits the departure information to the vehicle terminal.

27. The transportation call server of claim 26, wherein the control unit is further configured to assign the vehicle to the passenger, in response to an accept message transmitted from the vehicle terminal.

28. The transportation call server of claim 27, wherein the control unit is further configured to transmit a vehicle assignment message to the passenger terminal.

29. The transportation call server of claim 28, further comprising a vehicle assignment information storage configured to store information on real time assignment of the vehicle to the passenger.

30. The transportation call server of claim 28, wherein the control unit is further configured to: generate estimated arrival time indicating an expected arrival time of the vehicle at a departure point using the departure information and the vehicle position information; and transmit the estimated arrival time to the passenger terminal through the data communication unit.

31. The transportation call server of claim 28, wherein the control unit is further configured to: cancel a vehicle assignment in response to a cancel request transmitted from the passenger terminal; and transmit a cancelation message to the vehicle terminal through the data communication unit.

32. The transportation call server of claim 28, wherein the control unit is further configured to: generate estimated arrival time using the vehicle position information of the selected vehicle and the departure information; and transmit the estimated arrival time to the passenger terminal.

33. The transportation call server of claim 26 further comprising a vehicle information database (DB) configured to store information on the vehicle,
wherein the control unit is further configured to, in response to receiving an inquiry request transmitted from the passenger terminal, load vehicle information on the vehicle from the vehicle information DB and transmit the loaded vehicle information.

34. The transportation call server of claim 33, wherein the control unit is further configured to: generate a distance information between the passenger terminal and the vehicle terminal, using passenger terminal position information and the vehicle terminal position information; and transmit the distance information to the passenger terminal.

35. The transportation call server of claim 34, wherein the control unit is further configured to: generate an estimated arrival time; and transmit the estimated arrival time to the passenger terminal.

36. The transportation call server of claim 26, wherein the control unit is further configured to receive vehicle identification information for identifying the vehicle from other vehicles.

37. The transportation call server of claim 36 further comprising a vehicle information database (DB) configured to store information on the vehicle,
wherein the control unit is further configured to: identify at least one of a type of the vehicle and a district the vehicle belongs to; generate the vehicle position display information; and transmit the vehicle position display information to the passenger terminal,
wherein the passenger terminal is configured to distinguishably display the vehicle according to the received vehicle position display information.

38. The transportation call server of claim 37, wherein the type of the vehicle comprises personal transportation vehicles for transporting persons to a single destination, shared transportation vehicles for transporting persons to a multiple destinations, and cargo vehicles for transporting goods.

39. The transportation call server of claim 36 further comprising a vehicle assignment information storage configured to store information on real time assignment of the vehicle to the passenger,
wherein the control unit is further configured to: determine whether the vehicle has been assigned to another passenger using the vehicle assignment status; generate the vehicle position display information distinguishable according to a result of the determining; and transmit the vehicle position display information to the passenger terminal.

40. The transportation call server of claim 26 further comprising a map database (DB) storing maps and geographic information.

41. The transportation call server of claim 26, wherein the control unit is further configured to receive destination information from the passenger terminal.

42. The transportation call server of claim 41, wherein the control unit is further configured to transmit the destination information to the vehicle terminal.

43. The transportation call server of claim 41, wherein the control unit is further configured to: generate an estimated transportation fee using the departure information and the destination information; and transmit the estimated transportation fee to the passenger terminal.

44. A method for providing a transportation call service in response to a passenger's vehicle selection through communication with a transportation call server, the method performed by a passenger terminal capable of wireless communication, comprising:
receiving vehicle position information of a plurality of transportation vehicles from the transportation call server, wherein the vehicle position information is provided by each of the plurality of transportation vehicles;
displaying position of each of the plurality of vehicles on a map according to the vehicle position information;
transmitting destination information to the transportation call server;
selecting a vehicle from the plurality of vehicles displayed on the map; and
transmitting a vehicle selection signal to the transportation call server.

45. The method of claim 44 further comprising:
receiving a vehicle assignment message confirming assignment of the selected vehicle from the transportation call server; and
displaying the vehicle assignment message in response to receiving the vehicle assignment message.

46. The method of claim 45 further comprising:
receiving estimated arrival time from the transportation call server; and
displaying the estimated arrival time.

47. The method of claim 45 further comprising transmitting a riding schedule message to a predetermined terminal.
